(19) United States
(12) Patent Application Publication
(10) Pub. No.: US 2009/0313072 A1
(43) Pub. Date: Dec. 17, 2009

(54) COMPUTER-BASED VEHICLE ORDER TRACKING SYSTEM

(75) Inventors: Rebecca Jean Balok, Greenwood, MO (US); Linda Marie Jakubowski, Northville, MI (US); Victor Joseph Kudyba, Northville, MI (US); Bardia Madani, West Bloomfield, MI (US); Michael Cavaretta, Plymouth, MI (US); Paul Marchetti, Canton, MI (US); Kathleen Sue Barnes, Grosse Pointe Farms, MI (US); John C. Forest, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 12/138,156

(22) Filed: Jun. 12, 2008

(51) Int. Cl. G06Q 10/00

(52) U.S. Cl. 705/8

(57) ABSTRACT

A computer-implemented system for receiving a delivery estimated time of arrival (ETA) of an expected vehicle at a customer location is provided. The system comprises at least one customer system for receiving the ETA of the expected vehicle at the customer location from at least one tracking tool. The at least one tracking tool is configured to receive historical vehicle order average information which corresponds to known ETAs of one or more delivered vehicles over a predetermined time frame. The at least one tracking tool is further configured to generate at least one linear regression model in response to the historical vehicle order average information to determine the ETA of the expected vehicle at the customer location.

### BACKGROUND

1. Technical Field

One or more embodiments of the present invention generally relate to a computer-based vehicle order tracking system.

2. Background Art

Vehicle delivery estimated time of arrival (ETA) information is relied upon by various customers. Such customers may be both internal and external to a particular vehicle manufacturer. Customers may include fleet customers, individual customers (e.g., individuals who purchase vehicles) and vehicle dealers.

Many times, the individual customers purchase a vehicle that is not available at the dealer location at the time of purchase, thus necessitating production and delivery of the vehicle to the dealer location at a later date. This situation commonly arises when a customer wants a customized vehicle. In these instances, the dealer commonly provides the customer with a delivery ETA for the vehicle upon purchase.

In the event the customer is a vehicle dealer, personnel at the dealer typically conduct market studies of vehicles to identify particular vehicles that will sell at their dealer location. Often, such vehicles identified by the study are not available at the dealer location. In these instances, the dealer will contact the manufacturer to inquire as to whether the manufacturer can provide such vehicles. If the manufacturer has the capacity, the dealer's next question is when will the vehicles arrive at the dealership, i.e., a delivery ETA.

In the event the customer is a fleet manager, the fleet manager may identify a group of vehicles necessary to carry out the objectives of the fleet. Similar to the dealers' approach, the fleet manager checks with the manufacturer for capacity to fulfill an order for the group of vehicles, and a delivery ETA.

In all cases, the delivery ETA is commonly computed based on the vehicle manufacturer's inventory, the extent of customization, number of vehicles requested, etc. Delivery ETA is difficult to estimate since many parties may be involved with the vehicle delivery logistics plan. For example, the logistics plan may include upfitters, carriers, manufacturers, ramp operators, and dealers. Due to the complexity of the logistics concerning vehicle delivery, many current methods for calculating vehicle delivery ETAs for customers have been historically inaccurate and unreliable, leading to customer dissatisfaction.

### SUMMARY

In at least one embodiment, a computer-implemented system for receiving a delivery estimated time of arrival (ETA) of an expected vehicle at a customer location is provided. The system comprises at least one customer system for receiving the ETA of the expected vehicle at the customer location from at least one tracking tool. The at least one tracking tool is configured to receive historical vehicle order average information which corresponds to known ETAs of one or more delivered vehicles over a predetermined time frame. The at least one tracking tool is further configured to generate at least one linear regression model in response to the historical vehicle order average information to determine the ETA of the expected vehicle at the customer location.

### BRIEF DESCRIPTION OF THE DRAWINGS

FIG. 1 depicts a computer-based vehicle order tracking system according to one embodiment of the present invention;

FIG. 2 depicts a detailed diagram of the computer-based vehicle order tracking system according to one embodiment of the present invention;

FIG. 3 depicts ETA forecasts and bounds across various vehicle build/transit milestones according to one embodiment of the present invention; and

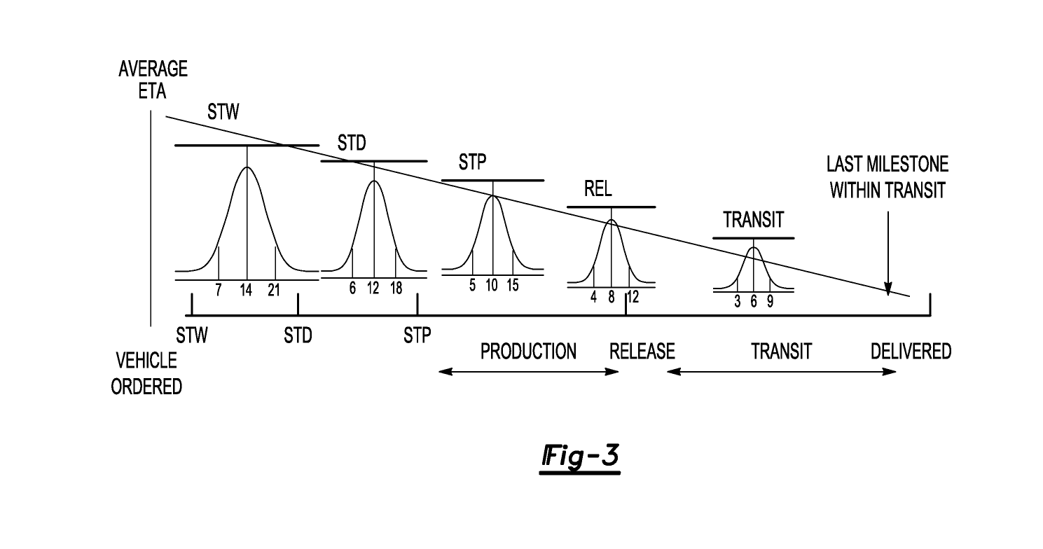

FIG. 4 is a block diagram for integrating the ETA forecast model and the bound model in an ETA generator according to one embodiment of the present invention.

### DETAILED DESCRIPTION OF THE EMBODIMENTS OF THE PRESENT INVENTION

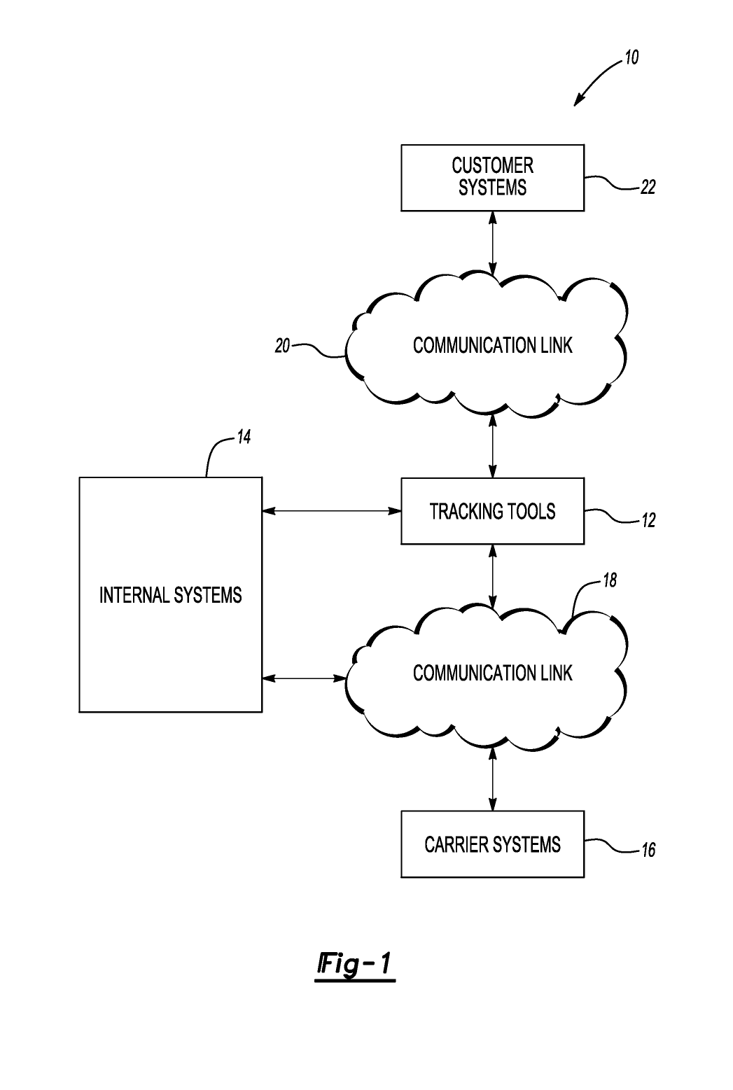

Referring now to FIG. 1, a block diagram of a computer-based vehicle order tracking system 10 according to one embodiment of the present invention is shown. The system 10 includes one or more tracking tools 12, one or more internal systems 14, one or more carrier systems 16, and one or more customer systems 22. The internal systems 14 generally correspond to systems that are under the control of an original equipment manufacturer (OEM). The OEM may maintain the tracking tools 12 and the internal systems 14. The internal systems 14 generally include one or more databases or computer-based systems for transmitting electronic data to the tracking tools 12. The tracking tools 12 is configured to access codes from the internal systems 14. Such codes may correspond to supplier codes, dealer codes, upfitter codes, plant codes, carrier codes, or other such suitable codes generally assigned to a party or place that is involved in the transit or delivery of vehicles from an assembly plant to the customer location.

The carrier systems 16 are generally configured to communicate information related to the status of a particular vehicle while in transit from the assembly plant to the customer location. Such information is communicated over a communication link 18 to the tracking tools 12. The carrier systems 16 may include various computer-based systems associated with or operated by a rail carrier, a convoy carrier, and/or an ocean carrier. The link 18 may include an electronic hub (e-hub), a file transfer protocol (FTP), or any other such suitable data communication links generally situated to facilitate data exchange between various computer systems.

The customer systems 22 are generally configured to receive information related to the status of a particular vehicle while in transit from the tracking tools 12. The customer systems 22 may include various computer-based systems associated with or operated by various dealers; fleets; material, planning, and logistic (MP&L) activities; and/or marketing, sales and service (MS&S) activities, rental companies, and/or governmental agencies. Such activities may directly receive vehicles from the assembly plant or need to know the status of the vehicle while in transit to provide a status of the vehicle while in transit. The tracking tools 12 generally include a portal that can be accessed via a communication link by users of the customer systems 22. In one example, the tracking tools 12 may be implemented as a web-based portal and provide information related to the status of the vehicle and ETA of the vehicle at any point during the manufacturing of the vehicle. The tracking tools 12 may also provide status information while the vehicle is in transmit between the vehicle assembly plant and the dealership (or other customer) to the customer systems 22. The communication link 22 may be any data link generally situated to facilitate data exchange between various computer systems. In addition to providing vehicle transit status and the ETA, the tracking tools 12 may also be configured to generate various alarms and alerts based on the ETA to trigger proactive investigation of vehicle status and location when a lack of movement in the transit chain is detected or when there is no advance in status of the vehicle while in transit.

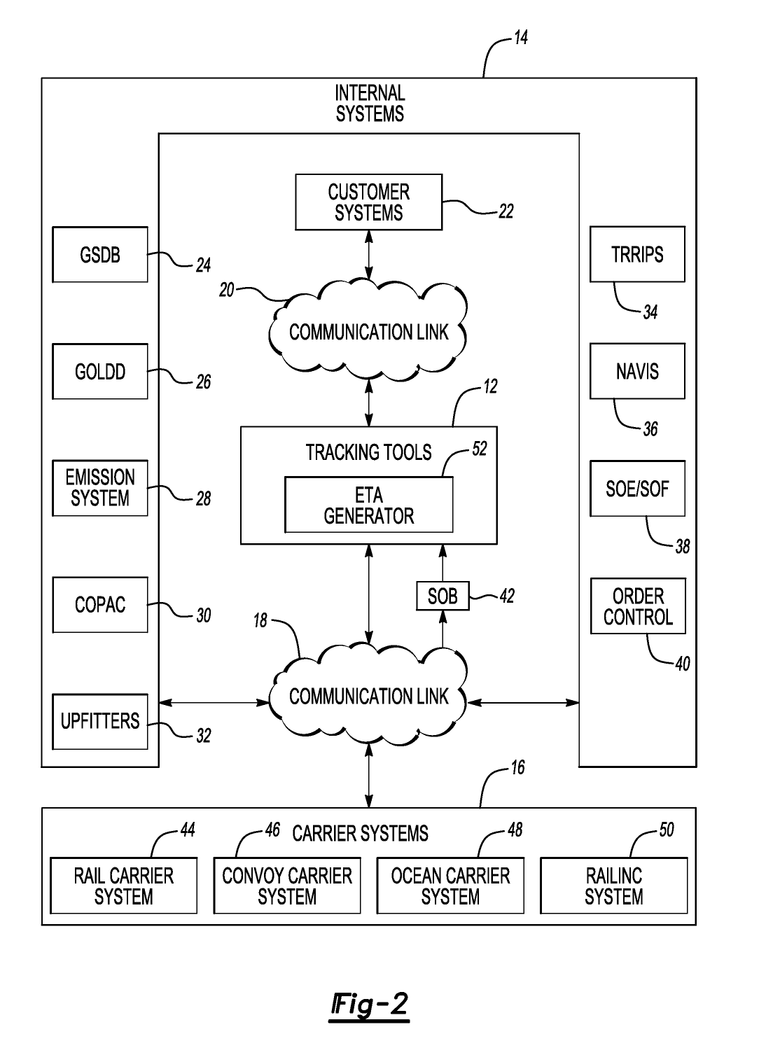

Referring now to FIG. 2, a detailed diagram of the computer-based vehicle order tracking system 10 in accordance to one embodiment of the present invention is shown. The internal systems 14 generally comprise a global supplier database (GSDB) 24, a global on line dealer database (GOLDD) 26, an emissions lab computer system 28, a centralized outbound payment authorization and control (COPAC) computer-based system 30, an upfitters computer-based system 32, a travel request and reimbursement information processing system (TRIPPS) 34, a North American vehicle information system (NAVIS) 36, a single order bank (SOB), single order edit (SOE) computer-based system 38, and an order control computer-based system 40. In general, the various computer-based systems within the internal systems 14 are designated to include various internal activities under the control of the OEM.

GSDB 24 is a system that may be used to validate and display information related to various suppliers, plants, carriers, and upfitters. The GSDB 24 contains one or more supplier codes, the various names of the supplier, and supplier locations. The GSDB 24 also contains codes related to the plants, carriers, and upfitters. The tracking tools 12 may use the information provided by the GSBD 24 to validate and translate carrier, plant, and upfitter (e.g., supplier) codes and converts such data for presentation to the customer systems 22.

GOLDD 26 is a system that may be used to validate and display dealer information. GOLDD 26 includes all dealer codes, names, and locations for the dealers. GOLDD 26 further includes a standard point location code (SPLC) for each dealer location. In general, the SPLC may be a numeric code that is developed for each freight originating point and each freight receiving point in North America. As used in the context of dealers, each dealer may be characterized as a freight originating point and a freight receiving point. For example, a dealer may be referred to as a point of freight origination in the event the dealer transfers the vehicle. In addition, a dealer may be referred to as a freight receiving point in the event such a dealer receives a vehicle.

The emissions lab computer system 28 provides the status of recently assembled vehicles that are in the process of having emissions tests performed. Such emission tests may be in the form of an exhaust emission measurement system (EEMS) testing status. For example, a certain allotment of vehicles that are built per year and designated for use in North American may undergo emissions testing at a test facility to demonstrate that such vehicles meet emission standards as set by the federal government. Such testing may effect the delivery of the vehicle to the dealer. The emission lab computer system 28 provides status as to when the tests were initiated, completed, and when the vehicle is transported from the emission test facility by way of a particular carrier.

COPAC 30 may be an OEM vehicle freight payment authorization system. COPAC 30 transmits information to the tracking tools 12, which generally corresponds to:

1) rail shipped transaction information which ties a particular vehicle identification number (VIN) of a vehicle to a particular rail car ID number that delivered the vehicle,

2) a route code of the vehicle,

3) ramp names generally corresponding to a designated location in which a rail carrier can stop and drop off a vehicle. The vehicle is then loaded onto a truck for delivery to a dealer (or other customer location). The designated location may be assigned to a major city, e.g., Los Angeles, or may be shared between less populated states; and

4) Standard point location code (SPLC) translation to location names.

While COPAC 30 directly provides such information to the tracking tools 12 via an internal communication bus, e.g., internal to the OEM, COPAC 30 may optionally transmit information to the tracking tools 12 via the communication link 18. For example, COPAC 30 may provide route codes and switchout information to the tracking tools 12 via the e-hub. Each route code is an alpha-numeric code where a first digit in the code designates the shipment mode, e.g., rail or convoy, a second digit in the code designates a particular mixing center, and additional digits may in the code generally represent the final destination ramp code the vehicle is routed to on its way to a final dealer (or customer) destination. As noted above, the link 18 may be an e-hub. The e-hub is generally configured to facilitate communication in real time between the tracking tools 12 and the carrier systems 16.

In one or more embodiments, a switchout is the state of a rail trip whereby a particular VIN for a vehicle is assigned to the rail car. The tracking tools 12 may be configured to determine the location of the VIN based on the location of the rail car while it is in transit. Because COPAC 30 relies on information provided by various carrier systems 16, such information is presented over the e-hub which is generally used to facilitate real time communication between outside systems (e.g., carrier systems 16) and the tracking tools 12. The e-hub allows the real time transfer of information between portions of the internal systems 14 and the carrier systems 16 and eliminates batch over night processing conventionally used which adds a 1-2 day delay in status and location availability.

The upfitter computer-based systems 32 include computer systems generally associated with, while not limited to, body companies, modifiers, and vehicle personalization centers. The upfitter class as defined above is generally not affiliated with the OEM and offers customers an opportunity to have options installed on their vehicles that are not available for installation by the plants that belong to the OEM. Such options that may be installed include, but are not limited to, snow plows, police units, taxis, appearance packages, racks/bins, and different types of truck bed conversions. The upfitter computer-based systems 32 transfer information with respect to the delivery and status of the particular type of option to be installed on a particular vehicle (e.g., date of vehicle receipt, date when a particular aftermarket operation started/completed, date of transfer of vehicle from upfitter). Such information is generally transmitted over the e-hub to the tracking tools 12.

In one or more embodiments, TRRIPS 34 tracks railcar shipments from all origin rail ramp locations to all destination rail ramp locations. TRRIPS 32 transmits railcar and Car Location Messages (CLMs) in real time from every railroad reporting point in North America to the tracking tools 12. NAVIS 36 is a repository which provides vehicles having a SOLD status to the tracking tools 12. Not every vehicle shipped to a dealer from the plant is sold while the vehicle is delivered from the plant to the dealer. Nonetheless, the tracking tools 12 may provide status and ETA information for such vehicles that are sold.

The SOE computer-based system 38 is generally responsible for receiving, managing, and editing (or amending) dealer orders. The SOF computer-based system 38 is generally responsible for scheduling the order of the vehicle with a designated assembly plant and determining the week assignment in which the plant will build the vehicle at the designated assembly plant.

The order control computer-based system 40 generally monitors plant status from the time the order is serialized (e.g., the time a vehicle order has a VIN assigned to it) until the vehicle is shipped from the plant. A single order bank (SOB) computer-based system 42 is a data repository that is linked to the tracking tools 12 and provides a centralized location for storing vehicle order detail, vehicle status, and vehicle location. The SOB computer-based system 42 transmits such information to the tracking tools 12. The SOE/SOF computer-based system 38 is configured to transmit dealer order (including amended orders), scheduling information (e.g., week assignment) to the SOB computer-based system 42 and to the tracking tools 12. In addition, the order control computer-based system 40 transmits the monitored plant status from the time the order is serialized to the time the vehicle is shipped from the plant to the SOB computer-based system 42. The SOB computer-based system 42 then transmits such data to the tracking tools 12.

The carrier systems 16 include a rail carrier computer-based system 44, a convoy carrier computer-based system 46, an ocean carrier computer-based system 48, and a railinc system computer-based system 50. In general, the carrier systems 16 are generally configured to transmit data to the tracking tools 12 via the e-hub or through a file transfer protocol (FTP). FTP is generally defined as a data link protocol that is used to facilitate data transmission over a secure link. The carrier systems 16 have the option of using the e-hub or FTP for transmitting information to the tracking tools 12.

The carrier systems 16 are generally configured to provide electronic data corresponding to real time status and the location of the vehicle while the vehicle is in transit for display by the tracking tools 12. The real time status and location may include production data, carrier real time receipts, rail car passing locations, and/or modification center status. The carrier systems 16 also provide real time damage notification to the tracking tools 12 to notify dealers. The carrier systems 16 may also provide insurance inspection based damage characterization to the tracking tools 12 for immediate disposition and notification to all interested parties in the customer systems 22. With such an insurance inspection damage characterization, affected dealers are capable of immediately reordering vehicles from the vehicle manufacturer. The tracking tools 12 may generate alarms or alerts based on the ETA to trigger proactive investigation of vehicle status and location.

The tracking tools 12 allow various customers to search for a vehicle by VIN and order number. The tracking tools 12 provide advanced search capability which includes order related attributes (e.g., order type, plant, special build code, priority code, region, purchase order number, special order number, and fleet incentive program); transportation related attributes (e.g., carrier name, current vehicle location, and in-route to ramp code), status and data related attributes (e.g., ETA date, invoice date, production week, and allocation week), and vehicle-line related attributes (e.g., model year, vehicle line, and options/features).

The tracking tools 12 include an ETA generator 52 for calculating the ETA for vehicles in transit between the plant and the dealer (or other customer). The ETA generator 52 employs linear regression techniques which take into account historical averages at various milestones to calculate the ETA. Such milestones are generally keyed off of vehicle build schedule events at the plant and vehicle transit events (e.g., the delivery of the vehicle from the plant to the dealer (or other customer)).

For example, the ETA generator 52 takes into account historical averages at the following milestones:

(1) Scheduled to the week (STW)—Order scheduled to the week (e.g., week in which the vehicle is scheduled to be built at the plant), serialization is generally defined as the point in time in which the vehicle is assigned a VIN and may occur just prior to the STW milestone;

(2) Scheduled to the day (STD)—Order scheduled to the day (e.g., day in which the vehicle is scheduled to be built at the plant);

(3) Sent to plant (STP)—Order sent to plant, (e.g., STP may take place approximately six days prior to the vehicle being produced. At STP, the plant has responsibility for producing and releasing the order/VIN;

(4) Release—Order released to the carrier for shipment;

(5) Transit—Unlike milestones (1)-(4) where the ETA may be calculated once, the ETA generator 52 may calculate the ETA on a real-time basis whenever a vehicle passes a designated transit point for the transit milestone. Transit events are tracked by the carrier systems 16. Transit events occur whenever a vehicle passes a designated point, e.g., city, or arrives at a location. The carrier systems 16 transmit transit events to the tracking tools 12. While it is possible to have multiple transit records transmitted per day by the carrier systems 16 to the ETA generator 52 for calculating the ETA, the ETA generator 52 may calculate the ETA once per day.

As noted above, the ETA generator 52 utilizes historical averages at each milestone to determine the ETA for a particular vehicle that is in transit. Thus, it is possible to trace a specific VIN or other such unique identification code assigned to a vehicle through the milestones and to its final delivery and calculate the ETA.

In general, the ETA generator 52 employs a fixed model with historical averages to calculate the ETA. Such a model may use a partial set or a full set of historical data and supplement the data with a table of historical averages. The historical averages table generally includes data associated with each milestone, the starting location (e.g., assembly plant or transit point), the city of the final delivery, and the average number of days over the last n months needed to travel from the starting location to the final delivery city. In one example, n may be to six months. The historical averages are recalculated on a periodic basis (e.g., hourly, daily, monthly or weekly). The averages contained in the table change over time, thereby allowing the ETA generator 52 to adjust to changing business conditions. The ETA generator 52 may employ a machine learning algorithm as set forth in: (i) “Data Mining—Practical Machine Learning Tools and Techniques”; second edition, by I. Witten and E. Frank, Morgan Kaufmann, San Francisco, 2005, and (ii) “Machine Learning”; by T. Mitchell, McGraw-Hill, 1992.

Predicting the ETA for an ordered vehicle generally includes the ETA in days, and the bound around the forecast. In order to provide an accurate ETA analysis, the ETA generator 52 employs an ETA forecast model (or equation) and a bound model (or equation). The ETA forecasting model is built from a number of input variables (e.g., see Table 1 below). Such variables are stored in a database which corresponds to historical vehicle order information. An absolute error on the results generated from the ETA forecast model is then used to construct the bound model.

TABLE 1

| Variable name | Description |
|---|---|
| PLANT | Plant where the vehicle is manufactured, |
| | i.e., point of origin. |
| TRANSIT STATE | State or province of the originating |
| | assembly plant. |
| TRANSIT CITY | City of the originating assembly plant. |
| FINAL STATE | State or province of the final destination |
| | dealer (or other customer). |
| FINAL CITY | City the final destination dealer (or other |
| | customer). |
| TRANSTYPE | The transportation type for a particular |
| | vehicle order. Transportation types |
| | include, without limitation, rail, convoy, |
| | and major junction points. |
| TRANSIT TIME | The actual transit time from the historical |
| | database of vehicle orders. |
| AVG TRANSIT | The average transit time from the |
| TIME | historical table for a particular |
| | combination of transit state, transit city, |
| | final state, final city and transportation |
| | type. |
| STD DEV | Similar to AVG TRANSIT TIME for the |
| | standard deviation. |
| MIN | Similar to AVG TRANSIT TIME for the |
| | minimum. |
| MAX | Similar to AVG TRANSIT TIME for the |
| | maximum. |
| DAY OF THE | DOW corresponds to when the transit record |
| WEEK (DOW) | was generated. Monitoring such a variable |
| | takes into account vehicle orders that pass |
| | a particular milestone that may be left |
| | waiting on certain days of the week. |
| HOUR | Hour, as measured from 0 to 24, when the |
| | transit record was generated. Similar to |
| | the day of the week variable, vehicle |
| | orders that pass a certain milestone late |
| | in the day may require an extra day for |
| | delivery. |
| RECORD COUNT | A count of the number of historical records |
| | for vehicles moving through a designated |
| | route. |

The ETA generator 52 is configured to apply a separate linear regression model (or equation) for each milestone. For example, the ETA generator 52 may include five linear regression models for the ETA forecast and five linear regression models for the bound forecast. The bound around the forecast generally corresponds to upper and lower limits of the ETA provided by the ETA generator 52. For example, the ETA generator 52 may provide an ETA for a particular vehicle at 8 days and a bound around the ETA of ±2 days (e.g., the ETA for a vehicle to arrive at the dealer (or other customer may be 8 days ±2 days).

An example of an ETA forecasting linear regression model for vehicles in the transit milestone is set forth in EQ. 1 below.

ETAFORECAST=1.1506×TRANSITTIME_Average+0.2408×Hour=23 H+−0.4791×Hour=07 H−0.1541×Hour=09 H+−0.6131×Hour=10 H−0.5052×Hour=06 H+1.2158×PLANT=AP03A−0.5658×Hour=15 H+−0.1226×Hour=02 H−0.4787×Hour=13 H+1.0471×PLANT=AP05A−0.1279×Hour=20 H+−0.2683×Hour=12 H+1.2359×PLANT=AP20A+−0.8035×Hour=05 H−0.3804×Hour=16 H+−0.2404×Hour=08 H−0.4092×Hour=14 H+−0.7544×Hour=11 H−0.1438×TRANSITTIME_Min+−0.0649×TRANSTYPE=2transtype+1.0639×PLANT=AP04A−0.6755×Hour=01 H−0.6646×Hour=04 H+0.2364×DOW=7DOW−0.234×Hour=18 H+0.9867×PLANT=G9W1A−0.1788×Hour=03 H+−0.1092×TRANSITTIME_{—}SDev+−0.2055×TRANSTYPE=22transtype+0.2382×DOW=6DOW−0.7259×Hour=00 H+0.1849×DOW=2DOW+0.18×DOW=1DOW+1.0685×PLANT=AP24A+0.1905×DOW=4DOW+−0.107×TRANSTYPE=9transtype+1.1255×PLANT=AP09A+1.0688×PLANT=AP06A+−0.2402×TRANSTYPE=24transtype+−0.0011×TRANSITTIME_Max+−0.8305

The ETA generator 52 may apply EQ. 1 at one or more milestone (e.g., STW, STP, release, and transit). It is generally contemplated that one or more of the variables and/or coefficients may change or vary from milestone to milestone. It is also contemplated that EQ. 1 may include other variables or coefficients other than those shown above. The variables and/or coefficients as shown in EQ. 1 are shown for illustrative purposes. For the coefficients placed before Hour, Plant, Transtype, and DOW variables as identified in EQ. 1, such coefficients represents the fraction of a day that should be added or subtracted from the ETA forecast. For example, the reference to ‘−0.4791×Hour=07 H’ of EQ. 1 indicates that the ETA forecast may be adjusted down a half day of when a particular vehicle passes a transit location at seven o'clock in the morning. All of the other variables (e.g., variables starting with ‘TRANSITTIME’) are inserted into the EQ. 1 from the historical average table and is generally considered as a percent contribution. For example, the reference to ‘1.1506×TRANSITTIME_Average’ of EQ. 1 corresponds to 115% of the average transit time. The coefficient ‘−0.4791’ may correspond to an average that is derived by tracking a year's worth of historical data at seven o'clock in the morning. In other words, for all of the coefficients shown that are multiplied by the average transit time, hour, etc. (e.g., 1.1506 through −0.0011) as illustrated in EQ. 1, such coefficients may be derived by averaging historical data that is accumulated over a year's worth of time. The time period to accumulate historical data for the purpose of generating an average may vary based on the desired criteria of a particular implementation. The transit time data as illustrated in EQ. 1 may comprise historical averages data derived over a thirty day period. The variable DOW1 corresponds to a day of the week that is Sunday and DOW 7 corresponds to a day of the week that is Saturday. Vehicles having abnormal issues with respect to manufacturing or while in transit may be removed from the historical data to allow for a more accurate ETA determination. For example, vehicles having a quality hold, or from produced from a new model launch may be removed from the historical data that is used to generate the vehicle order averages.

An example of a bound linear regression equation for vehicles in the transit milestone is set forth in EQ. 2 below.

TRANSIT_ETA_Bound=0.5202×TRANSITTIME_{—}SDev+0.3572×PLANT=AP20A+−0.2201×Hour=16 H+0.2635×ETAFORECAST+0.3295×PLANT=AP04A+0.2472×Hour=02 H+−0.1752×Hour=15 H+0.1613×Hour=18 H+0.1864×Hour=00 H+−0.1194×DOW=3DOW+0.1705×Hour=23 H+−0.321×Hour=22 H+0.2137×PLANT=G9W1A+−0.3639×Hour=20 H+−0.1076)×DOW=2DOW+−0.0997×DOW=6DOW+−0.1095×TRANSTYPE=24TRANSTYPE+−0.0861×TRANSITTIME_Mean+0.1038×TRANSTYPE=9TRANSTYPE+0.1227×PLANT=AP24A+−0.1559×TRANSITTIME_Min+−0.0142×TRANSITTIME_Max+−0.032

All of the variables included in EQ. 2 are the same as EQ. 1 with the exception of ETAFORECAST. ETAFORECAST is the result or end product of EQ. 1. The ETA generator 52 may apply EQ. 2 (or an equation similar to EQ. 2) for each milestone (e.g., STW, STD, STP, release, and transit). The coefficient ‘−0.2201’ as shown above in EQ. 2 is an average that may be derived by tracking a year's worth of historical data at four o'clock in the evening. In other words, for all coefficients shown that are multiplied by the average transit time, hour, etc. (e.g., 0.5202 through −0.0142), such coefficients may be derived by taking the average of historical data that is accumulated for a year's worth of time. The transit time data may comprise historical average data over a thirty day period so that such data may take into current or recent trends. The time period to accumulate historical data for the purpose of generating an average may vary based on the desired criteria of a particular implementation. The ETA generator 52 may quickly determine the bound of the ETA with EQ. 2 without utilizing post-processing analysis techniques.

The ETA generator 52 may also take into account additional variables listed below in addition to those identified above for determining the forecastable ETA as noted in connection with FIG. 1 and for determining the bound around of the forecasted ETA as noted in connection with EQ. 2. Such variables may include:

An exception code to indicate whether a vehicle ships through another location as opposed to its normal planned route. For example, a hurricane may force the rerouting of vehicle orders through locations different than the original plan. The exception codes may be provided by the carrier systems 16.

A quality hold flag to indicate that a vehicle was produced but held at the assembly plant to fix a quality issue. Without this information it may not be known whether a vehicle was delayed in transit, or was being held at the plant. The quality hold flag may be provided by the internal systems 16.

The standard point location code (SPLC) of the final location (e.g., a Ford dealer); SPLC is similar to Zip code and may allow for a larger number of vehicles to be pooled for historical averages. SPLCs may be provided by the internal systems 16.

An emission lab flag which corresponds to a small percentage of vehicles are required by law to be tested for emissions. These vehicles are shipped from the assembly plant to the emission testing laboratory and from there to their final destination. Emission testing adds at least two weeks to the transit time of these vehicles. The emission lab flag may be transmitted by the emission computer-based system 28.

A route code which indicates the route from the assembly plant to the vehicle's final destination. A change in the route code may indicate a change in the physical route and may effect the vehicle's ETA. The route code may be determined by the codes contained in COPAC 30.

A ship thru code which indicates whether the vehicle is being shipped to a body company before shipment to its final destination. Certain ship thru codes may impact transit time from one day to several weeks, depending on the modification. The ship through code may be transmitted by the internal systems 14 and/or the carrier systems 16.

As noted above, the ETA generator 52 employs a fixed model with historical averages to determine the forecast ETA and the bound around the ETA. However, the ETA 52 may employ other such machine models such as a dynamic model or a fixed model to determine the forecast ETA and the bound around the ETA. For example, the dynamic model may use historical vehicle order data over a predetermined time frame to automatically build an ETA forecasting model. The dynamic model may need little human intervention and may regenerate an ETA forecasting algorithm when the accuracy of the currently generated model falls below a predetermined threshold or on a specified interval (e.g., monthly).

The dynamic model is generally adapted to remain current with changes that may occur over time with respect to the historical vehicle order data. For example, as business conditions change (e.g., rail routes either added or deleted), the dynamic model may automatically adapt and keep ETA accuracy high. On the other hand, the dynamic model may present an increase in complexity. The ETA generator 52 may employ the dynamic model as set forth in “C4.5 Program For Machine Learning”; by J. R. Quinlan, Morgan Kaufmann, 1993.

With the fixed model, human intervention may be needed to provide the data needed to determine the forecasted ETA. For example, all of the historical data needed by a person to build or generate the forecasted ETA may need to be kept. In the event, the fixed model falls below a desired accuracy (or predetermined threshold), the fixed model may need to be rebuilt manually by mathematical modelers. The fixed model may not provide for an automatic adjustment to changing business conditions as exhibited with the fixed model with historical averages and the dynamic model. In general, the fixed model with historical averages presents less complexity than the dynamic model. As noted above, the fixed model with historical averages may take into account averages that change over time allowing the ETA generator 52 to adjust to changing business conditions.

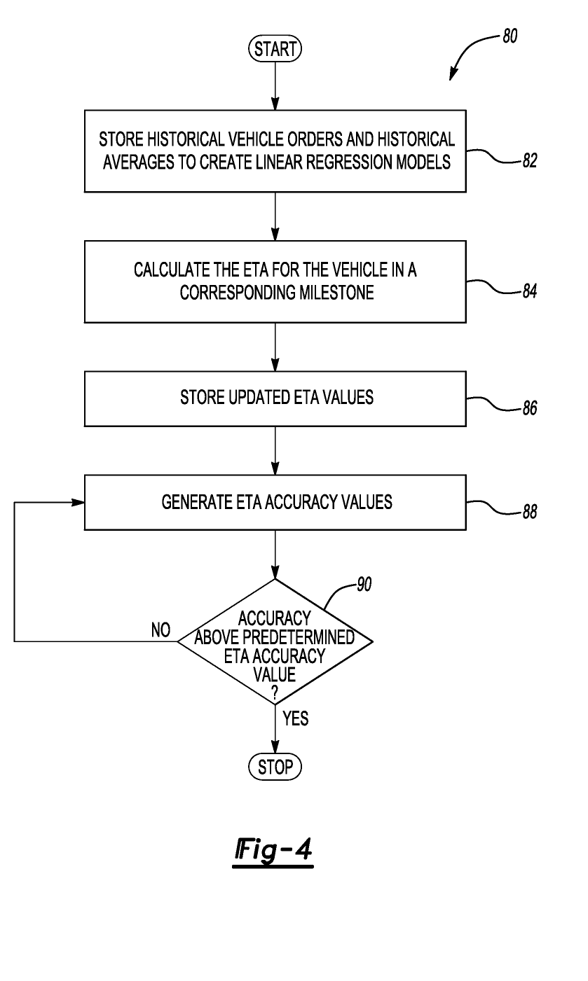

Referring now to FIG. 4, a block diagram 80 for integrating the ETA forecast model and the bound model in the ETA generator 52 is shown. The integration of the ETA forecasting model and the bound model into the ETA generator 52 may be accomplished with the following operations.

In block 82, the ETA generator 52 stores historical vehicle orders (or VINS) and a table with historical averages of known ETAs at each milestone. Vehicle order information may be transmitted to the ETA generator 52 by the internal systems 14 (e.g., GSDD 24, the SOE/SOF computer-based system 38, the order control computer-based system 40, and/or SOB computer-based system 42). Transit information may be transmitted to the ETA generator 52 via the carrier systems 16. The ETA generator 52 creates and stores the ETA forecast linear regression equation (e.g., EQ. 1) and the bound linear regression (e.g., EQ. 2) equation for each milestone in response to the historical vehicle orders and the historical vehicle order averages of vehicle having known or actual ETAs. As noted above, the historical averages of known ETAs may vary based on a number of criteria. For example, the historical averages takes into account the assembly plant (or starting point) at each affected milestone (e.g., STW, STD, STP, and RELEASE), the transit point and city of final delivery while the vehicle is in the TRANSIT milestone. In general, each assembly plant may have different averages with respect to the STW, STD, STP, and RELEASE milestones. Likewise, since there are a number of transit points for a vehicle to pass through while in transit and a number of final delivery cities that are capable of receiving vehicles, each transit point and final delivery city may have different historical averages from one another.

In block 84, the ETA generator 52 calculates the ETA for the vehicle in a corresponding milestone (e.g., STW, STD, STP, RELEASE, and TRANSIT) with an equation similar to or equal to EQ. 1 (or an equation similar to EQ. 1). For example, in the event the vehicle is to be assembled at the Kentucky Truck Plant (KTP) in Louisville, Ky., the ETA generator 52 use an equation similar to or equal to EQ. 1 which takes into account historical data specifically for KTP at each milestone STW, STD, STP, and RELEASE and calculates the ETA at each milestone. The ETA may be adjusted based on the milestone the vehicle is in at the plant (e.g., STW, STD, STP, and RELEASE). In the event the vehicle is to be delivered from Louisville to Detroit, the ETA generator 52 may use EQ. 1 (or an equation similar to EQ. 1), which takes into account historical data that correspond to each transit point between Louisville and Detroit to determine the ETA. Again, the ETA may be recalculated once the vehicle is detected to have passed through one or more transit points anywhere between Louisville and Detroit while in transit.

In block 86, the tracking tools 12 store the updated ETA values calculated in block 84.

In block 88, the ETA generator 52 generates ETA accuracy value(s) periodically that are based on vehicles with actual ETAs (as opposed to forecasted ETAs) to test the accuracy of the linear equations generated in block 82.

In block 90, the ETA generator 52 compares the ETA accuracy values to a predetermined ETA accuracy value. If the ETA accuracy value is less than the predetermined ETA accuracy value, then the diagram 80 moves back to block 82. In one example, the predetermined ETA accuracy value may be less than 70%.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An computer-implemented system for receiving a delivery estimated time of arrival (ETA) of an expected vehicle at a customer location, the system comprising:
at least one customer system for receiving the ETA of the expected vehicle at the customer location from at least one tracking tool that is configured to receive historical vehicle order average information which corresponds to known ETAs of one or more delivered vehicles over a predetermined time frame and to generate at least one linear regression model in response to the historical vehicle order average information to determine the ETA of the expected vehicle at the customer location.

2. The computer-implemented system of claim 1, wherein the at least one tracking tool is further configured to generate the at least one linear regression model for at least one milestone event which corresponds to at least one of a vehicle build scheduling event of the expected vehicle and transit information corresponding to the expected vehicle being in transit between the vehicle assembly plant and the customer location.

3. The computer-implemented system of claim 2, wherein the vehicle build scheduling event corresponds to at least one of a scheduled week in which the expected vehicle is expected to be built at the vehicle assembly plant, a scheduled day in which the vehicle is expected to be built at the assembly plant, and a release date in which the expected vehicle is released from the assembly plant.

4. The computer-implemented system of claim 1 wherein the tracking tool is further configured to collect historical vehicle order average information for one or more delivered vehicles over at least one milestone event which corresponds to at least one of a vehicle build scheduling event of the one or more delivered vehicles and transmit information of the one or more delivered vehicles.

5. The computer-implemented system of claim 1 wherein the at least one customer system is further configured to receive a recalculated ETA for the expected vehicle as the expected vehicle passes through predetermined transit points between the vehicle assembly plant and the customer location.

6. The computer-implemented system of claim 1 wherein the at least one customer system is further configured to receive real time alerts to notify the customer location in the event a vehicle delay is detected as the vehicle passes through predetermined transit points.

7. The computer-implemented system of claim 1 wherein the at least one customer system is further configured to receive damage notification of the expected vehicle in the event the expected vehicle is damaged as the expected vehicle passes through predetermined transit points.

8. The computer-implemented system of claim 1 wherein the at least one customer system is further configured to:
receive the ETA of the expected vehicle in response to the at least one tracking tool generating an ETA forecast linear regression model based on the historical vehicle order average information to determine the ETA of the expected vehicle at the customer location; and
receive upper and lower limits of the ETA of the expected vehicle in response to the at least one tracking tool generating a bound around linear regression model based on the historical vehicle order average information to determine the upper and lower limits of the ETA of the expected vehicle at the customer location.

9. A computer-implemented system for determining a delivery estimated time of arrival (ETA) of an expected vehicle at a customer location, the system comprising:
at least one tracking tool configured to:
determine historical vehicle order average information which corresponds to known ETAs of one or more delivered vehicles over a predetermined time frame;
generate at least one linear regression model in response to the historical vehicle order average information; and
generate the ETA of the expected vehicle at the customer location in response to executing the at least one linear regression model.

10. The computer-implemented system of claim 9 further comprising at least one customer system operably coupled to the at least one tracking tool for receiving the ETA fo the expected vehicle.

11. The computer-implemented system of claim 9 wherein the tracking tool is further configured to generate the at least one linear regression model in response to the historical vehicle order average information for at least one milestone event which corresponds to at least one of a vehicle build scheduling event of the expected vehicle and transit information corresponding to the expected vehicle being in transit between the vehicle assembly plant and the customer location.

12. The computer-implemented system of claim 11 wherein the vehicle build scheduling event corresponds to at least one of a scheduled week in which the expected vehicle is expected to be built at the vehicle assembly plant, a scheduled day in which the vehicle is expected to be built at the assembly plant, and a release date in which the expected vehicle is released from the assembly plant.

13. The computer-implemented system of claim 11 wherein the at least one tracking tool is further configured to determine the historical vehicle order average information by collecting historical vehicle order average information for one or more delivered vehicle over at least one milestone event which corresponds to at least one of a vehicle build scheduling event of the one or more delivered vehicles and transmit information of the one or more delivered vehicles.

14. The computer-implemented system of claim 9 wherein the at least one tracking tool is further configured to recalculate the ETA for the expected vehicle as the expected vehicle passes through predetermined transit points between the vehicle assembly plant and the customer location.

15. The computer-implemented system of claim 9 wherein the tracking tool is further configured to generate real time alerts to notify at least one customer system in the event a vehicle delay is detected as the vehicle passes through predetermined transit points.

16. The computer-implemented system of claim 9 wherein the tracking tool is further configured to provide damage notification to at least one customer system in the event the expected vehicle is damaged as the vehicle passes through predetermined transit points.

17. A computer-implemented system for determining a delivery estimated time of arrival (ETA) of an expected vehicle at a customer location, the system comprising:
at least one tracking tool configured to:
determine historical vehicle order average information which corresponds to known ETAs of one or more delivered vehicles over a predetermined time frame;
generate an ETA forecast linear regression model in response to the historical vehicle order average information;
generate a bound around linear regression model in response to the historical vehicle order average information;
determine the ETA of the expected vehicle at the customer location in response to executing the ETA forecast linear regression model, and
determine upper and lower limits with respect to the ETA of the expected vehicle in response to executing the bound around linear regression model; and
at least one customer system operably coupled to the at least one tracking tool and configured to receive the ETA of the expected vehicle and to receive the upper and lower limits with respect to the ETA of the expected vehicle.

18. The computer-implemented system of claim 17 wherein the at least one tracking tool is further configured to generate real time alerts to notify the at least one customer system in the event a vehicle delay is detected as the vehicle passes through predetermined transit points.

19. The computer-implemented system of claim 17 wherein the at least one tracking tool is further configured to provide damage notification to the at least one customer system in the event the expected vehicle is damaged as the vehicle passes through predetermined transit points.

20. The computer-implemented system of claim 17 wherein the tracking tool is further configured to recalculate the ETA for the expected vehicle and the upper and lower limits for the recalculated ETA in response to the expected vehicle passing through predetermined transit points between the vehicle assembly plant and the customer location.
